(19) United States
(12) Patent Application Publication
(10) Pub. No.: US 2026/0080907 A1
(43) Pub. Date: Mar. 19, 2026

(54) MODULAR ARCHITECTURE FOR HARD DISK DRIVE STORAGE SYSTEM

(71) Applicant: Western Digital Technologies, Inc., San Jose, CA (US)

(72) Inventors: John Contreras, Palo Alto, CA (US); Joey Martin Poss, Rochester, MN (US); Xinzhi Xing, San Jose, CA (US); Nina Prabhu, Fremont, CA (US); Daniel Oh, San Jose, CA (US); Satoshi Nakamura, Yokohama (JP); Miki Namihisa, Fujisawa (JP); Kendall Hayne Fung, Longmont, CO (US)

(21) Appl. No.: 18/887,906

(22) Filed: Sep. 17, 2024

(51) Int. Cl. G11B 33/12; G11B 25/04

(52) U.S. Cl. CPC G11B 33/126; G11B 25/043

(57) ABSTRACT

A modular data storage system includes a shared main PCB comprising at least one system controller, configured to operate with multiple stacked storage devices, such as modified hard disk drives in which most of the drive-unique components are kept on each drive. Each storage device is mechanically and electrically connected with the main PCB at or near an end of the storage device, and the controller is centrally positioned on the main PCB so that the total electrical transmission line length between the storage devices and the controller circuitry is minimized. Further, the controller circuitry may be positioned on the main PCB so that each electrical transmission line length between a respective storage device and the controller circuitry is substantially equivalent. Signal integrity is significantly simplified for high-speed interfaces and shorter interconnects help meet timing requirement for low-speed interfaces.

### FIELD OF EMBODIMENTS

Embodiments of the invention may relate generally to data storage, and particularly to high-density and flexible hard disk drive storage platform.

### BACKGROUND

A hard disk drive (HDD) is a non-volatile storage device that is housed in a protective enclosure and stores digitally encoded data on one or more circular disks having magnetic surfaces. When an HDD is in operation, each magnetic-recording disk is rapidly rotated by a spindle system. Data is read from and written to a magnetic-recording disk using a read-write head (or transducer) that is positioned over a specific location of a disk by an actuator. A read-write head makes use of magnetic fields to write data to and read data from the surface of a magnetic-recording disk. A write head works by using the current flowing through its coil to produce a magnetic field. Electrical pulses are sent to the write head, with different patterns of positive and negative currents. The current in the coil of the write head produces a localized magnetic field across the gap between the head and the magnetic disk, which in turn magnetizes a small area on the recording medium.

As networked computing systems grow in numbers and capability, there is a need for more data storage capacity. Enterprise, cloud computing/storage, and large-scale data processing environments further increase the need for digital data storage systems (generally, “data centers”) that are capable of transferring and holding significant amounts of data. One approach to providing sufficient data storage in data centers is the use of arrays of data storage devices typically configured and provisioned as one or more data storage systems.

For example, one such approach to vast data storage is referred to as a JBOD (Just a Bunch of Disks, or Just a Bunch of Drives), which is typically a collection of hard disk drives (HDDs) that may be exposed as independent devices or combined to operate as one logical volume.

Furthermore, there is an increasing need for archival data storage (also referred to as “cold storage”). Magnetic tape is a traditional solution for data back-up but is notably slow in accessing the stored data. Current archives are increasingly “active” archives, meaning some level of continuing random read data access is required. There are a number of advantages that may be enabled by a magnetic disk data library over a traditional tape library, in addition to faster access time. In terms of magnetic media cost, magnetic disks in HDDs have the lowest demonstrated cost per terabyte (e.g., $/Tb). Furthermore, magnetic disks are known to have a relatively lengthy useful life, especially when maintained in a controlled environment, whereby the magnetic bits on the media will remain stable for a relatively long time.

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive (HDD), according to an embodiment;

FIG. 2 is a perspective view schematic illustrating a modular data storage system, according to an embodiment;

FIG. 3A is a perspective view illustrating a hard disk drive with interposer electrical connectivity, according to an embodiment;

FIG. 3B is a perspective view illustrating a hard disk drive with custom housing electrical connectivity, according to an embodiment;

FIG. 4A is a schematic diagram illustrating a single-channel modular data storage system, according to an embodiment;

FIG. 4B is a schematic diagram illustrating a dual-channel modular data storage system, according to an embodiment;

FIG. 5A is a side view schematic diagram illustrating a modular data storage system with interposer electrical connectivity, according to an embodiment;

FIG. 5B is a side view schematic diagram illustrating a modular data storage system with custom housing electrical connectivity, according to an embodiment;

FIG. 6A is a perspective view illustrating a modular data storage system with interposer electrical connectivity, according to an embodiment;

FIG. 6B is a perspective view illustrating electrical connectivity of the modular data storage system of FIG. 6A, according to an embodiment;

FIG. 6C is a perspective view illustrating an interposer board of the modular data storage system of FIG. 6A, according to an embodiment;

FIG. 7 is a side view schematic diagram illustrating a modular data storage system with interposer electrical connectivity, according to an embodiment; and

FIG. 8 is a table illustrating interposer electrical connectivity options, according to an embodiment.

### DETAILED DESCRIPTION

Generally, approaches to high-density modular data storage platform are described. In the following description, for the purposes of explanation, numerous specific details are set forth to provide a thorough understanding of the embodiments of the invention described herein. It will be apparent, however, that the embodiments of the invention described herein may be practiced without these specific details. In other instances, well-known structures and devices may be shown in block diagram form to avoid unnecessarily obscuring the embodiments of the invention described herein.

### INTRODUCTION

### Terminology

References herein to “an embodiment”, “one embodiment”, and the like, are intended to mean that the particular feature, structure, or characteristic being described is included in at least one embodiment of the invention. However, instances of such phrases do not necessarily all refer to the same embodiment,

The term “substantially” will be understood to describe a feature that is largely or nearly structured, configured, dimensioned, etc., but with which manufacturing tolerances and the like may in practice result in a situation in which the structure, configuration, dimension, etc. is not always or necessarily precisely as stated. For example, describing a structure as “substantially vertical” would assign that term its plain meaning, such that the structure is vertical for all practical purposes but may not be precisely at 90 degrees throughout.

While terms such as “optimal”, “optimize”, “minimal”, “minimize”, “maximal”, “maximize”, and the like may not have certain values associated therewith, if such terms are used herein, the intent is that one of ordinary skill in the art would understand such terms to include affecting a value, parameter, metric, and the like in a beneficial direction consistent with the totality of this disclosure. For example, describing a value of something as “minimal” does not require that the value actually be equal to some theoretical minimum (e.g., zero), but should be understood in a practical sense in that a corresponding goal would be to move the value in a beneficial direction toward a theoretical minimum.

Context Recall that there is an increasing need for archival data storage along with a continuing need for enterprise, cloud computing and storage, and large-scale data processing data centers. One approach to meeting the expansive need for large-scale storage of any form includes the use of disaggregated storage whereby, generally, compute resources are separated from storage resources. Thus, the different types of resources may be amenable to separately provisioning, controlling, maintaining, and the like. However, maximizing potential benefits from disaggregated storage may likewise benefit from a flexible high-density storage platform architecture. For example, one aspect of flexibility in a storage platform may include enabling the use of faster (relatively high IOPS, or input/output per second) as well as slower (relatively low IOPS) storage devices. Furthermore, implementation of any architecture for a high-density storage platform should not avoid consideration of performance and cost associated with the underlying storage devices.

Previous known approaches to archival storage platforms utilizing shared electronics have relied on significantly large PCBs (printed circuit boards) to serve the array of data storage devices, which require long electrical transmission lengths and which likely require high frequency electrical multiplexers as well. Those requirements in turn likely require the use of low-loss, high-cost PCB laminates, e.g., up to five times the cost of conventional PCB laminates.

### Modular Architecture for Hard Disk Drive Storage Platform

According to embodiments, a hard disk drive (HDD) multi-modular (HD-MM) architecture/design enables an HDD to be configured in multiple ways and capacities. As such, an HDD may operate in a single drive mode or as part of a group with other HDDs which operate through a shared printed circuit board (PCB) comprising a single or multiple electronic controllers (also referred to as controller circuitry, or “SOC” (system on a chip)). Hence, such a data storage system implemented in an HD-MM form is enabled to accommodate both low latency/IOPS configurations and high latency/IOPS configurations. For example, a HD-MM storage system may be provisioned in an “NxHDD T” configuration utilizing a single controller or in an “NxHDD parallel” configuration utilizing multiple controllers. In an NxHDD T configuration, one or more T-shaped connections (“T-connections”) may be implemented to branch into a single controller from the multiple HDDs, e.g., swappable HDDs primarily utilizing existing electronics. Alternatively, an NxHDD parallel configuration may be capable of mimicking multi-actuator architectures, e.g., with each controller independently operating with a corresponding logical unit of memory corresponding to the HDDs, while utilizing existing HDD mechanics. In either type of configuration, it is intended for a constituent HDD to be exchangeable with NxHDD parallel and NxHDD T configurations.

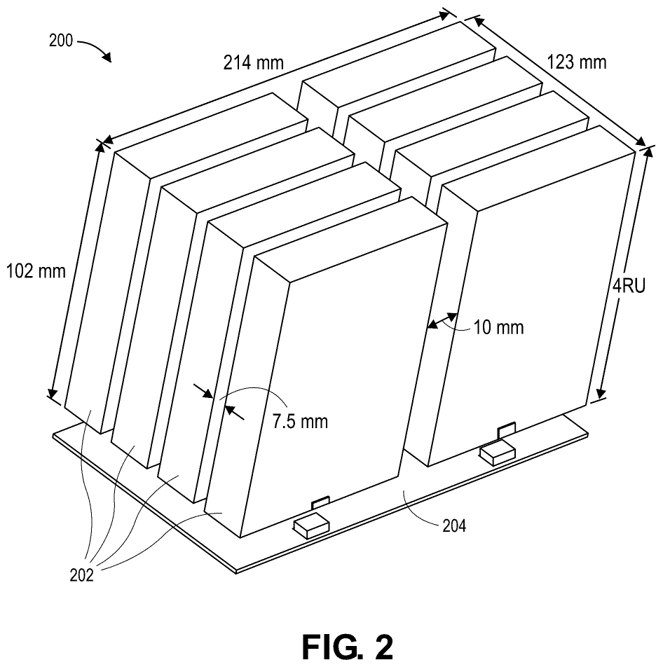

FIG. 2 is a perspective view schematic illustrating a modular data storage system, according to an embodiment. FIG. 2 simply illustrates an example “8×” data storage system 200 having eight HDDs 202 each coupled with or installed onto, e.g., in mechanical and electrical communication with, a common (i.e., shared) main PCB 204. Here, exemplary dimensions are included to depict that in a four-stacked configuration (4 HDDs stacked one on top of the other), such a system can fit in a 4U slot in multiple orientations (e.g., main PCB down, main PCB back), where “U” or “RU” refers to a standard rack unit or unit of measure defined as 1.75 inches (44.45 millimeters) in height. With a rack installation in which the main PCB 204 is installed down (on the bottom), the system/box is serviceable from the top and, therefore, HDDs 202 are readily replaceable.

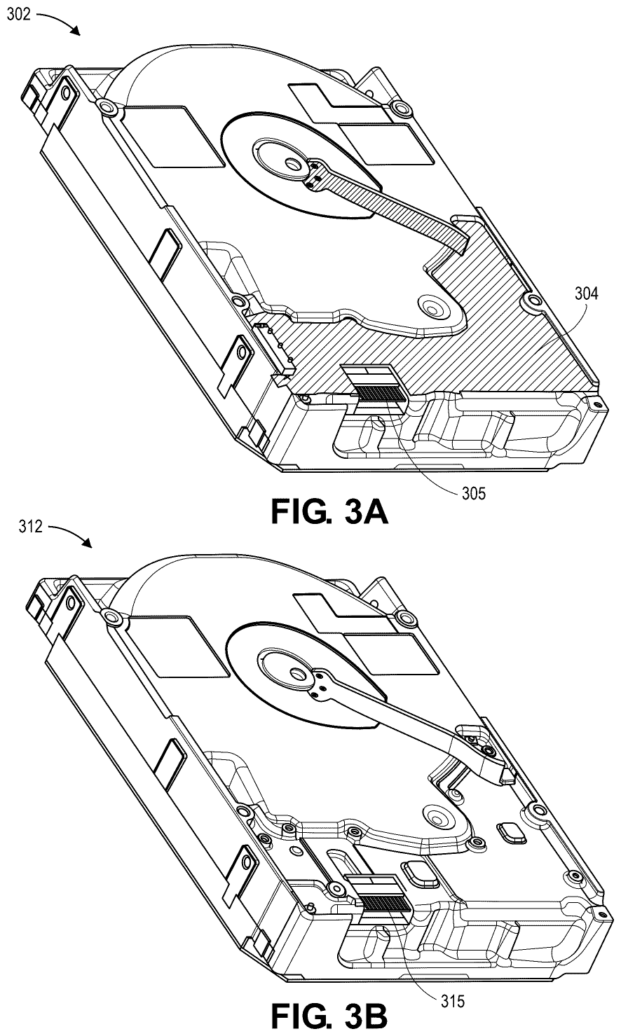

According to embodiments, an HDD configured for this HD-MM architecture can be one of two types. FIG. 3A is a perspective view illustrating a hard disk drive with interposer electrical connectivity, according to an embodiment. FIG. 3A illustrates an HDD 302 configured for interposer electrical connectivity, which is referred to herein as an HDD-IC (HDD-Interposer Connection). The HDD-IC form poses little physical placement change from a conventional HDD's PCB, as the current/traditional electronics except for the main controller/SOC are utilized. For example, the preamplifier, actuation controller(s) (e.g., voice coil motor (VCM), fine actuator(s)), motor controller(s) (e.g., disk spindle motor(s)), and sensor (e.g., temperature, rotational vibration, and the like) circuitry all remain on a modified PCB 304 to support a low-cost end connector 305 bus input, i.e., whereby an interposer board/bus is utilized to support I/Os (plural of input/output) between an HDD-IC and a main controller on a separate main PCB (see, e.g., main PCB 204 of FIG. 2) and additional controls if needed. With the HDD-IC form, the housing of a conventional HDD may be used to minimize manufacturing complexity and cost, and the associated interposer PCB is a low-cost minimum layer PCB (e.g., four layers, for a non-limiting example, with fewer vias) according to an embodiment.

FIG. 3B is a perspective view illustrating a hard disk drive with custom housing electrical connectivity, according to an embodiment. FIG. 3B illustrates an HDD 312 configured for custom housing electrical connectivity, which is referred to herein as an HDD-CH (HDD-Custom Housing). The HDD-CH form utilizes a new end connector 315 for bus input for supporting I/Os from a separate main PCB (see, e.g., main PCB 204 of FIG. 2) where the main controller/SOC is located, and an HDD PCB (see, e.g., PCB 304 of FIG. 3A) is eliminated. For example, the actuation controller(s) (e.g., VCM, fine actuator(s)), motor controller(s) (e.g., disk spindle motor(s)), and sensor (e.g., temperature, rotational vibration, and the like), etc. circuitry are moved internally to the HDD enclosure or can be placed on the main PCB 204. Accommodations for the spindle motor connections would be placed internally or utilize a jumper connection scheme that would reconnect to the connector 315.

### Data Storage System Signal Integrity

As discussed elsewhere herein, previous known approaches to archival storage platforms utilizing shared electronics have relied on significantly large PCBs to serve the array of data storage devices, which require long electrical transmission lengths (e.g., up to 300 mm) and which likely require high frequency electrical multiplexers as well. Those requirements in turn likely require the use of low-loss, high-cost PCB laminates, e.g., five times or more of the cost of conventional PCB laminates. For example, such low-loss dielectric manufacturing adds cost, and large laminate thermal issues require special pre-adjustments due to potential for component misalignment. Furthermore, there is limited opportunity for electrical T-connections with such long transmission lengths as electrical multiplexers are typically required in that context.

According to an embodiment, PCB interconnect losses are reduced by stacking HDDs (see, e.g., HDDs 202 of FIG. 2) in mechanical and electrical connection with the main board (see, e.g., main PCB 204 of FIG. 2). By stacking the HDDs 202 one over the next (e.g., vertical stacking) and, therefore, connecting each HDD 202 to the main PCB 204 with an end connector (at or near the longitudinal/back end of the HDD), efficient electrical transmission line lengths are enabled. Stated otherwise, stacking the HDDs 202 (e.g., rather than laying them all down in an array pattern over a main PCB) enables the main controller/SOC to be centrally positioned on the main PCB 204 such that the total electrical transmission line length between the HDDs 202 and the controller is minimized. According to an embodiment, the controller is positioned on the main PCB 204 such that each electrical transmission line length between a respective HDD 202 and the controller is substantially equivalent (e.g., similar while not necessarily absolutely identical).

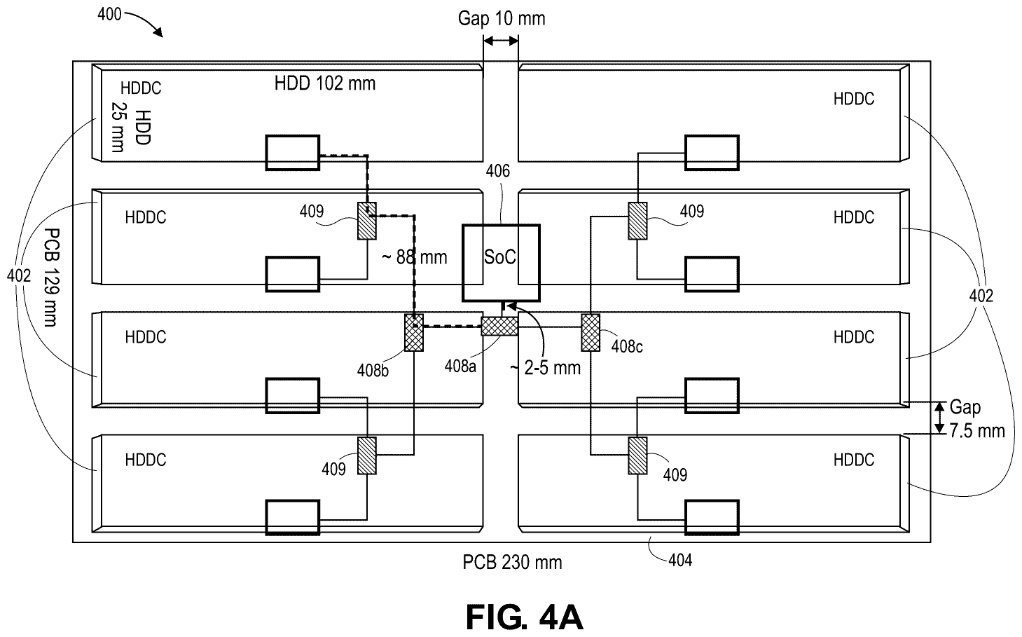

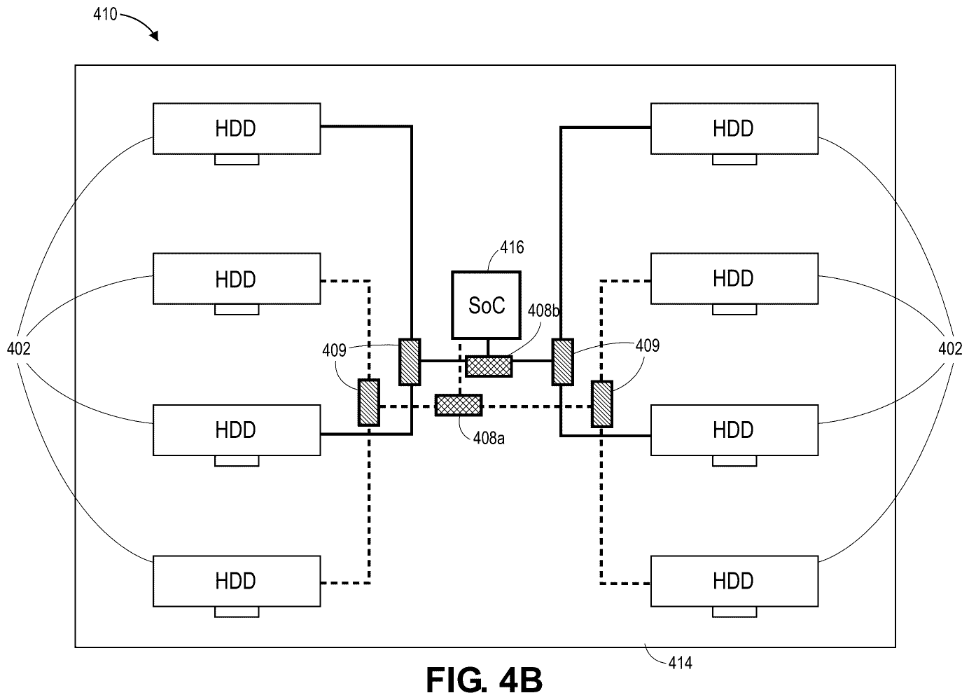

FIG. 4A is a schematic diagram illustrating a single-channel modular data storage system, according to an embodiment. Diagram 400 illustrates a 4×2 HDD 402 (or “HDDC” for HDD-Component comprising head disk assembly (HDA) mechanical components plus interposer connection) configuration, in which a single single-channel controller 406 is judiciously centrally positioned on main PCB 404 so that equivalent/near equivalent line length among the grouping of HDDs 402 is provided, i.e., at a given rate corresponding to the single-channel controller 406. In the context of a dual-channel controller 406 (e.g., at roughly 1.5 higher cost than a single-channel controller), or two single-channel controllers 406, the system could operate at a rate roughly two times the rate corresponding to the single controller 406.

Depicted in the example configuration of FIG. 4A is a main PCB 404 comprising multiplexer circuitry 408 (a “mux”, or simply “mux 408”) between a system controller circuitry 406 (simply “controller 406”) and multiple groupings of the HDD storage devices 402 (simply “HDDs 402”), and an electrical T-connection 409 between the mux 408 and each pair of HDDs 402 of each grouping of storage devices. Here, continuing with the example of an 8× storage system, each grouping of HDDs 402 contains two groupings (e.g., first and second groupings) of four stacked (shown vertically stacked here) HDDs 402 (a 2×4 configuration). Thus, a first mux 408a is utilized for selecting and routing the signal(s) transmitted from the controller 406 to each of the first and second groupings, a second mux 408b is utilized for selecting and routing each of those signal(s) transmitted from the first mux 408a to each of two pairs of the first grouping, and a third mux 408c is utilized for selecting and routing each of those signal(s) transmitted from the first mux 408a to each of two pairs of the second grouping. Furthermore, a T-connection 409 is utilized for routing each of those signal(s) transmitted from each of the second and third mux 408b, 408c to each HDD 402 of each pair of the first and second groupings.

With controller 406 generally centrally positioned on the main PCB 404 (in this example, 129 mm by 230 mm) and among the installed HDDs 402, and with consideration to the vertical and horizontal gaps between the stacked HDDs 402, the transmission line length between the controller 406 and each HDD 402 (through the series of muxes 408a-408c and T-connections 409) of this example is shown to be approximately 90-95 mm (approx. 2-5 mm from controller 406 to first mux 408a, plus approx. 88 mm from first mux 408a through a respective mux 408b, 048c to each HDD 402 (shown dashed for top left HDD)). Therefore, minimization of the total line length (and associated interconnect losses) and substantial equivalency among the individual line (trace) lengths/paths are enabled, at least in part by way of the symmetric/balanced layout of the HDDs 402. Hence, signal integrity is significantly simplified for high-speed interfaces and shorter interconnects help meet timing requirement for low-speed interfaces, which is to say that performance may improve over alternative storage systems. Further and to reiterate, relatively low-cost minimum layer PCB material may also be used here, rather than relatively high-cost low-loss PCB materials as with alternative systems. Note that with implementations of a main PCB 404 having multiple controllers 406, the line lengths can be expected to be even shorter as each controller 406 can be positioned closer to the corresponding grouping of HDDs 402 with which each controller 406 operates.

FIG. 4B is a schematic diagram illustrating a dual-channel modular data storage system, according to an embodiment. Diagram 410 illustrates a 4×2 HDD 402 configuration, in which a single dual-channel controller 416 is judiciously centrally positioned on main PCB 414 so that equivalent/near equivalent line length among the grouping of HDDs 402 is provided, i.e., at a given rate corresponding to parallel channels of the dual-channel controller 416. Depicted in the example configuration of FIG. 4B is a main PCB 414 comprising multiple (one for each channel of controller 416) multiplexer circuitry 408 between the dual-channel system controller circuitry 416 (simply “controller 416”) and multiple groupings of the HDDs 402, and T-connections 409 between each mux 408 and each pair of HDDs 402 of each grouping. Here, continuing with the example of an 8× storage system, each grouping of HDDs 402 contains two groupings (e.g., first and second groupings) of four stacked (shown vertically stacked here) HDDs 402 (a 2×4 configuration). Thus, a first mux 408a is utilized for selecting and routing the signal(s) transmitted from a first channel of the controller 416 to each of the first and second groupings, and a second mux 408b is utilized for selecting and routing the signal(s) transmitted from a second channel of the controller 416 to each of the first and second groupings. From there, a T-connection 409 is utilized for routing each of those signal(s) transmitted from each of the first and second mux 408a, 408b to each HDD 402 of each pair of the first and second groupings. Alternatively, a mux 408 may be implemented in place of a T-connection 409. Here also, minimization of the total line length (and associated interconnect losses) and substantial equivalency among the individual line (trace) lengths/paths and corresponding signal integrity benefits are enabled, at least in part by way of the symmetric/balanced layout of the HDDs 402.

### Storage Device Power Management

A power large scale integrated circuit (PLSI) refers to the power chip that controls the two main moveable components of an HDD: spindle motor and VCM. The SOC, the main drive controller, sends control signals to the PLSI, which would in turn control the VCM motion and spindle motor speed. PLSI is primarily analog so that it is not integrated into the SOC, which is primarily digital. In the context of a modular data storage system (HD-MM) architecture described herein, PLSI(s) placement depends on which configuration is employed, e.g., HDD-IC (FIG. 3A) or HDD-CH (FIG. 3B).

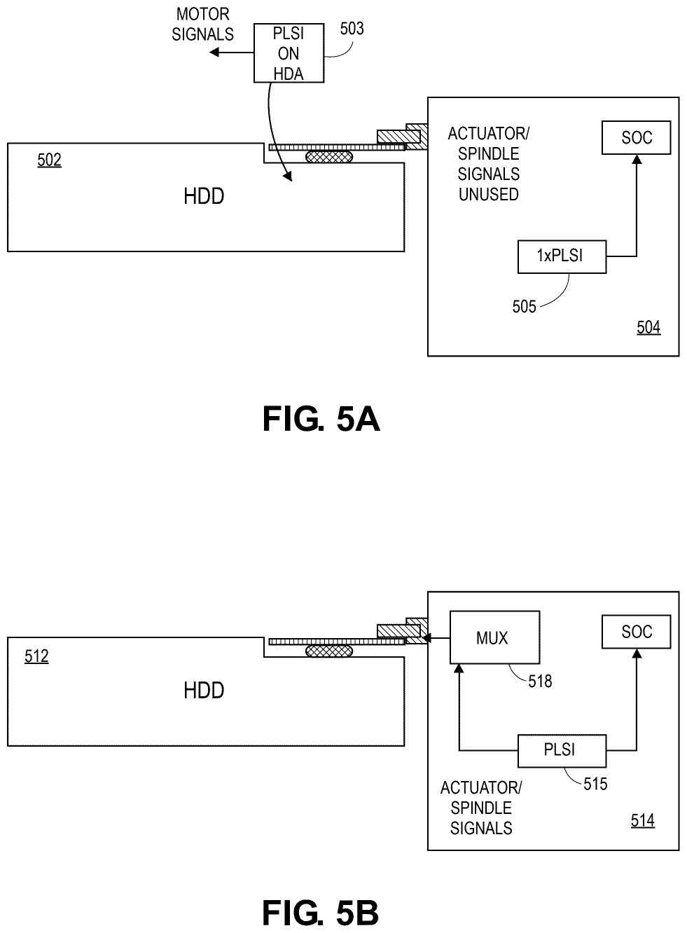

FIG. 5A is a side view schematic diagram illustrating a modular data storage system with interposer electrical connectivity, according to an embodiment. According to an embodiment, in the context of an HDD configured according to the HDD-IC form described herein, each HDD 502 (see also HDD 202 of FIG. 2, HDD 302 of FIG. 3A, HDD 402 of FIGS. 4A-4B) comprises a respective PLSI 503 chip. Further according to an embodiment, the main PCB 504 (see also main PCB 204 of FIG. 2, main PCB 404 of FIGS. 4A-4B) also comprises a PLSI 505 chip, restricting power planes to main PCB 504 area. Here, the actuator and spindle motor control signals from PLSI 505 are effectively unused, as the operating actuator and spindle motor control signals are dedicated from each PLSI 503 on each corresponding HDD 502. With respect to EPO (Emergency Power Off) situations, BEMF (Back Electromotive Force) can be provided by the PLSI 503 of the active HDDs 502, with routing to the PLSI 505 of the main PCB 504.

FIG. 5B is a side view schematic diagram illustrating a modular data storage system with custom housing electrical connectivity, according to an embodiment. According to an embodiment, in the context of an HDD configured according to the HDD-CH form described herein, the main PCB 514 (see also main PCB 204 of FIG. 2, main PCB 404 of FIGS. 4A-4B) comprises a PLSI 515 chip, whereby power planes are limited to main PCB 514 area. Here, the actuator and spindle motor control signals from PLSI 515 chip are transmitted to each HDD 512 (e.g., via a mux 518). Alternatively, main PCB 514 may comprise a respective PLSI 515 chip corresponding to each HDD 512. With the HDD-CH form, EPO is handled inherently. As such, in the scenario in which only one PLSI 515 chip is servicing multiple HDDs 512, PLSI 515 will operate as the active PLSI for getting the BEMF to provide the required power for EPO procedures.

### Interposer Connectivity Between Main PCB and HDDs

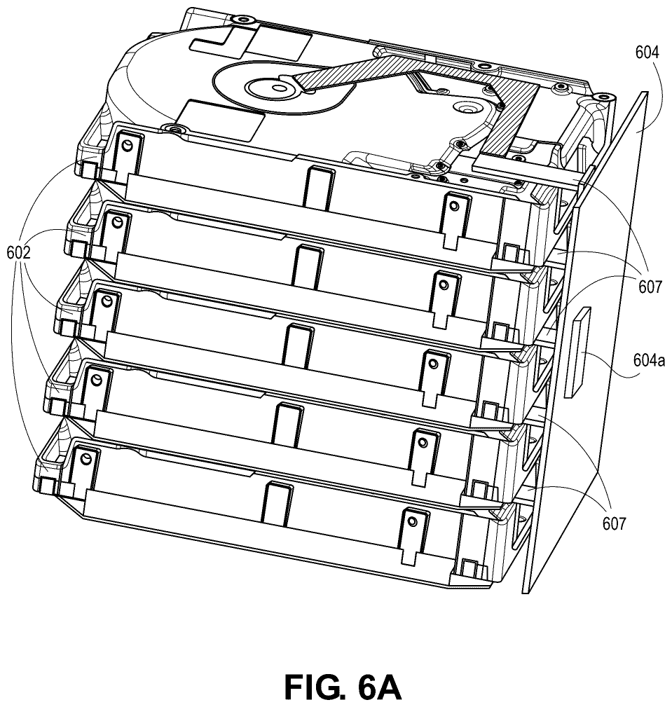

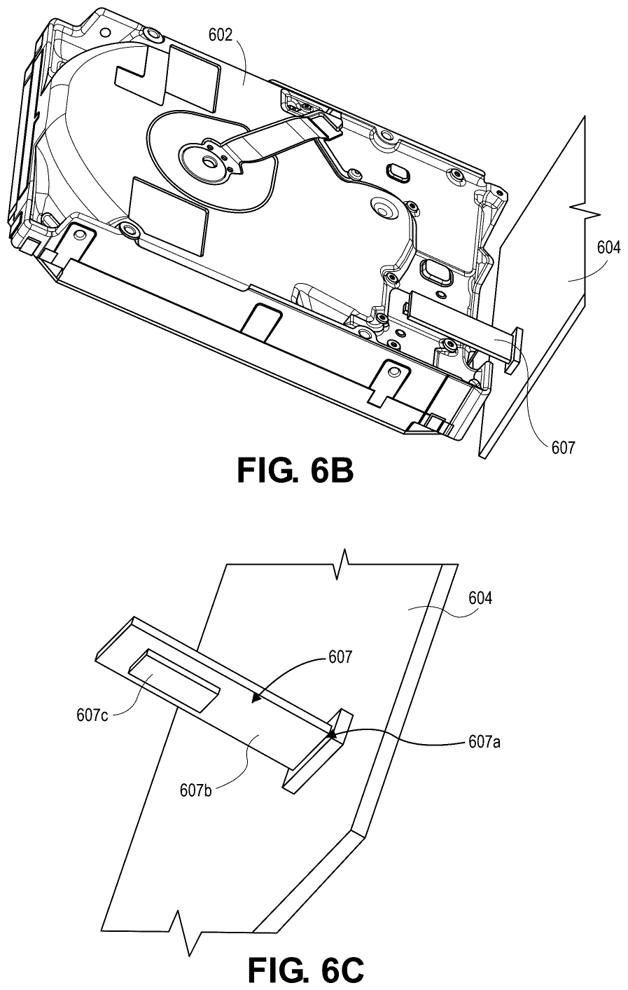

FIG. 6A is a perspective view illustrating a modular data storage system with interposer electrical connectivity, FIG. 6B is a perspective view illustrating electrical connectivity of the modular data storage system of FIG. 6A, and FIG. 6C is a perspective view illustrating an interposer board of the modular data storage system of FIG. 6A, all according to embodiments. In the context of a modular data storage system (HD-MM) architecture described herein, electrical (and mechanical) interconnection between each HDD 602 (see also HDD 202 of FIG. 2, HDD 302 of FIG. 3A, HDD 402 of FIGS. 4A-4B, HDD 502 of FIG. 5A, HDD 512 of FIG. 5B) and the main PCB 604 (see also main PCB 204 of FIG. 2, main PCB 404 of FIGS. 4A-4B, main PCB 504 of FIG. 5A, main PCB 514 of FIG. 5B), which is configured for electrical connection with one or more host via a host connector 604a, is needed for electrical transmission/communication (e.g., bus) purposes. For this connectivity purpose, according to embodiments interposer electrical connectivity is employed.

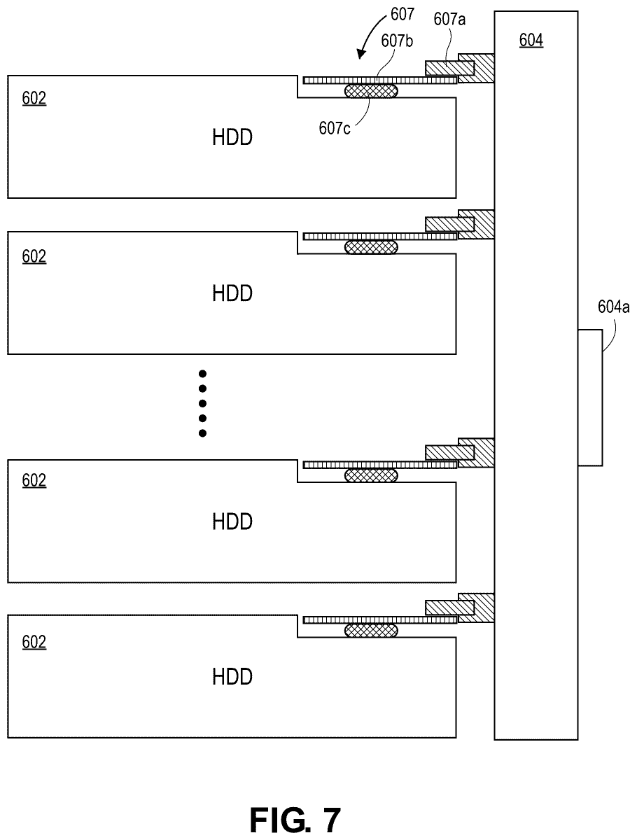

FIG. 7 is a side view schematic diagram illustrating a modular data storage system with interposer electrical connectivity, according to an embodiment. Interposer connectivity comprises a board connector 607a electrically connected to the main PCB 604, an interposer board 607b electrically connected to the board connector 607a and to an HDD connector 607c electrically connected to the HDD 602. According to an embodiment, interposer board 607b comprises a solid board (e.g., PCB). According to another embodiment, interposer board 607b comprises a flexible board (e.g., a flexible printed circuit or “FPC”).

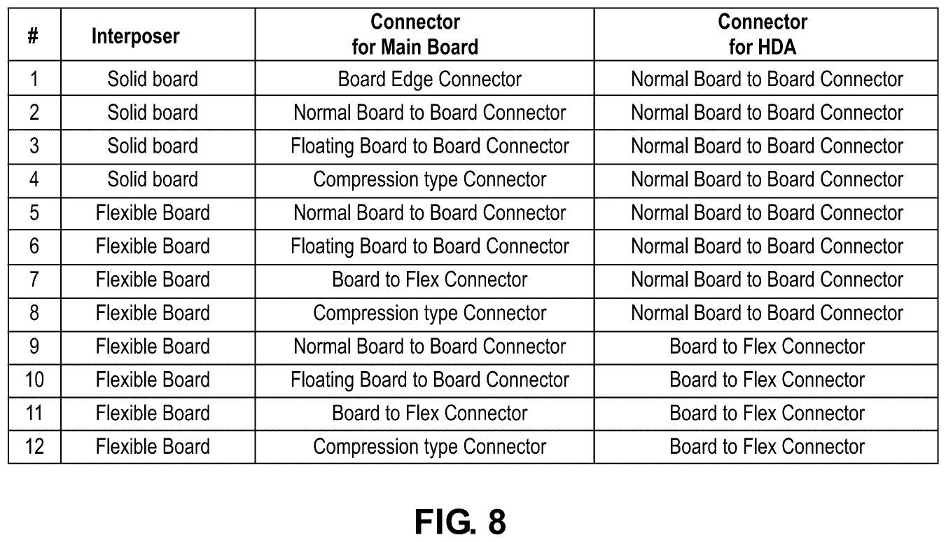

Furthermore, options for suitable types of electrical connectors for each of the board connector 607a and the HDD connector 607c are presented in the table of FIG. 8.

FIG. 8 is a table illustrating interposer electrical connectivity options, according to an embodiment. While such connectivity options are mainly applicable to HDD-IC, these connectivity options or related hybrid options can utilize a form of HDD-CH without a PCB 304 (see, e.g., FIG. 6A). With respect to use of a solid interposer board 607b (FIG. 7) (#s 1-4 of FIG. 8), a board connector 607a (FIG. 7) may be selected from a group consisting of the following connector types: (i) a board edge connector, (ii) a normal board-to-board (B2B) connector, (iii) a floating B2B connector, and (iv) a compression type connector. In this scenario, with board edge and normal B2B connectors, the alignment between each HDD 602 (FIGS. 6A-6B, 7) and main PCB 604 (FIGS. 6A-6C, 7) should be of higher accuracy because of less position margin for connector mating. Similarly with respect to use of a flexible interposer board 607b (#s 5, 6, 8 of FIG. 8), a board connector 607a may be selected from a group consisting of the following connector types: (ii) a normal B2B connector, (iii) a floating B2B connector, and (iv) a compression type connector. Here also with normal B2B connector, the alignment between each HDD 602 and main PCB 604 should be of higher accuracy because of less position margin for connector mating. Furthermore, with respect to use of a flexible interposer board 607b (#7 of FIG. 8), a board connector 607a may be a board to flex connector (B2F). In this scenario with a B2F connector, the alignment between each HDD 602 and main PCB 604 can be relaxed for connector mating, relative to the foregoing scenarios. In each of the foregoing connector implementations (#s 1-8 of FIG. 8), a normal B2B connector is used for HDD connector 607c (FIGS. 6C, 7), according to embodiments. Finally, with respect to use of a flexible interposer board 607b and a B2F HDD connector 607c (#s 9-12 of FIG. 8), a board connector 607a may be selected from a group consisting of the following connector types: (i) a board edge connector, (ii) a normal board-to-board (B2B) connector, (iii) a B2F connector, and (iv) a compression type connector.

According to the embodiments described herein for a modular hard drive-based data storage system, most of the HDD-unique components are kept on each drive, with other electronics (particularly controller and related circuitry, and including host connector, DRAM, and the like, according to embodiments) moved to a shared main PCB. PCB interconnect losses are reduced by stacking HDDs in mechanical and electrical connection with the main board, which enables efficient electrical transmission line lengths. That is, stacking the HDDs rather than laying them all down in an array pattern over a main PCB enables the main controller/SOC to be centrally positioned on the main PCB such that the total electrical transmission line length between the HDDs 202 and the controller is minimized.

### Hard Disk Drive Configuration

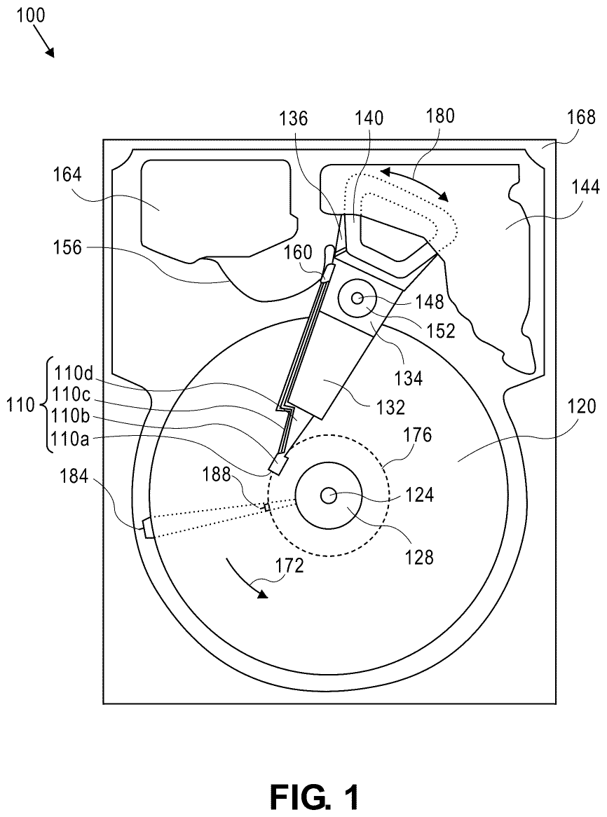

As discussed, embodiments may be used in the context of a data storage system in which multiple data storage devices (DSDs) including hard disk drives (HDDs) are employed. Thus, in accordance with an embodiment, a plan view illustrating a typical HDD 100 is shown in FIG. 1 to illustrate exemplary operating components. However, an HDDC (e.g., HDA mechanics having some but less than typical electronics, plus interposer), such as HDD-IC and/or HDD-CH as described herein, are preferred candidates for use in the HD-MM modular storage system architecture/platform described herein.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one recording medium 120 rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice coil motor (VCM) that includes an armature 136 including a voice coil 140 attached to the carriage 134 and a stator 144 including a voice-coil magnet (not visible). The armature 136 of the VCM is attached to the carriage 134 and is configured to move the arm 132 and the HGA 110 to access portions of the medium 120, all collectively mounted on a pivot shaft 148 with an interposed pivot bearing assembly 152. In the case of an HDD having multiple disks, the carriage 134 may be referred to as an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a head-stack assembly (HSA). An HSA may, however, include more or fewer components than those described. For example, an HSA may refer to an assembly that further includes electrical interconnection components. Generally, an HSA is the assembly configured to move the head slider to access portions of the medium 120 for read and write operations.

With further reference to FIG. 1, electrical signals (e.g., current to the voice coil 140 of the VCM) comprising a write signal to and a read signal from the head 110a, are transmitted by a flexible cable assembly (FCA) 156 (or “flex cable”, or “flexible printed circuit”). Interconnection between the flex cable 156 and the head 110a may include an arm-electronics (AE) module 160, which may have an on-board pre-amplifier for the read signal, as well as other read-channel and write-channel electronic components. The AE module 160 may be attached to the carriage 134 as shown. The flex cable 156 may be coupled to an electrical-connector block 164, which provides electrical communication, in some configurations, through an electrical feed-through provided by an HDD housing 168. The HDD housing 168 (or “enclosure base” or “baseplate” or simply “base”), in conjunction with an HDD cover, provides a semi-sealed (or hermetically sealed, in some configurations) protective enclosure for the information storage components of the HDD 100.

Other electronic components, including a disk controller and servo electronics including a digital-signal processor (DSP), provide electrical signals to the drive motor, the voice coil 140 of the VCM, and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (each may also be referred to as a “track sector”) such as sectored track portion 188. Each sectored track portion 188 may include recorded information, and a header containing error correction code information and a servo-burst-signal pattern, such as an ABCD-servo-burst-signal pattern, which is information that identifies the track 176. In accessing the track 176, the read element of the head 110a of the HGA 110 reads the servo-burst-signal pattern, which provides a position-error-signal (PES) to the servo electronics, which controls the electrical signal provided to the voice coil 140 of the VCM, thereby enabling the head 110a to follow the track 176. Upon finding the track 176 and identifying a particular sectored track portion 188, the head 110a either reads information from the track 176 or writes information to the track 176 depending on instructions received by the disk controller from an external agent, for example, a microprocessor of a computer system.

An HDD's electronic architecture comprises numerous electronic components for performing their respective functions for operation of an HDD, such as a hard disk controller (HDC), an interface controller, an arm electronics module, a data channel, a motor driver, a servo processor, buffer memory, etc., some but not necessarily all of which may be constituent to an HDDC as described herein. Two or more of such components may be combined on a single integrated circuit board referred to as a “system on a chip” (SOC). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass an information storage device that is at times referred to as a hybrid drive. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management, and control of the different types of storage media typically differ, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### Extensions and Alternatives

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps and are not intended to specify or require a particular order of carrying out such steps.

What is claimed is:

1. A data storage system comprising:
a main printed circuit board (PCB) comprising at least one system controller circuitry; and
a plurality of stacked storage devices, each storage device mechanically and electrically connected with the main PCB at or near a longitudinal end of the storage device;
wherein the system controller circuitry is centrally positioned on the main PCB such that a total electrical transmission line length between the plurality of storage devices and the system controller circuitry is minimized.

2. The data storage system of claim 1, wherein the system controller circuitry is positioned on the main PCB such that each electrical transmission line length between a respective storage device and the system controller circuitry is substantially equivalent.

3. The data storage system of claim 1, wherein the plurality of storage devices comprises a plurality of hard disk drives (HDDs).

4. The data storage system of claim 1, wherein:
the system controller circuitry comprises single-channel circuitry; and
the main PCB comprises:
a multiplexer circuitry between the system controller circuitry and at least two groupings of the storage devices; and
a T-connection between the multiplexer circuitry and each pair of storage devices of each grouping of storage devices.

5. The data storage system of claim 1, wherein the system controller circuitry comprises dual-channel circuitry.

6. The data storage system of claim 5, wherein the main PCB comprises:
a first multiplexer circuitry between one channel of the system controller circuitry and at least one first set of the storage devices; and
a second multiplexer circuitry between another channel of the system controller circuitry and at least one second set of the storage devices.

7. The data storage system of claim 6, wherein the main PCB further comprises:
a first T-connection between the first multiplexer circuitry and one pair of the first set of storage devices; and
a second T-connection between the first multiplexer circuitry and another pair of the first set of storage devices.

8. The data storage system of claim 1, wherein:
the plurality of storage devices comprises a plurality of hard disk drives (HDDs), each HDD comprising:
a plurality of disk media rotatably mounted on a motor spindle,
a plurality of head sliders, each head slider housing a read-write transducer configured to read from and to write to a disk medium of the plurality of disk media,
one or more actuators configured for moving the head sliders to access portions of the disk media, and
electronics including a preamplifier, an actuation controller, a motor controller, and sensor circuitry; and
the main PCB further comprises power large scale integrated (PLSI) circuitry configured for sending signals to the electronics of each HDD through a multiplexer on the main PCB.

9. The data storage system of claim 1, wherein:
the plurality of storage devices comprises a plurality of hard disk drives (HDDs), each HDD comprising:
a plurality of disk media rotatably mounted on a motor spindle,
a plurality of head sliders, each head slider housing a read-write transducer configured to read from and to write to a disk medium of the plurality of disk media,
one or more actuators configured for moving the head sliders to access portions of the disk media, and
electronics including power large scale integrated (PLSI) circuitry, a preamplifier, an actuation controller, a motor controller, and sensor circuitry.

10. The data storage system of claim 1, wherein the main PCB further comprises a plurality of independent system controller circuitry, each system controller circuitry configured for operating with a corresponding logical unit of memory corresponding to the plurality of storage devices.

11. The data storage system of claim 1, further comprising:
a plurality of solid interposer circuit boards, each solid interposer circuit board configured to electrically connect a corresponding connector of the main board with a corresponding board-to-board connector of a storage device of the plurality of storage devices;
wherein each main board connector is one from a group consisting of a board edge connector, a non-floating board-to-board connector, a floating board-to-board connector, and a compression-type connector.

12. The data storage system of claim 1, further comprising:
a plurality of flexible interposer circuit boards each configured to electrically connect a corresponding connector of the main board with a corresponding board-to-board connector of a storage device of the plurality of storage devices;
wherein each main board connector is one from a group consisting of a board-to-flex connector, a non-floating board-to-board connector, a floating board-to-board connector, and a compression-type connector.

13. The data storage system of claim 1, further comprising:
a plurality of flexible interposer circuit boards each configured to electrically connect a corresponding connector of the main board with a corresponding board-to-flex connector of a storage device of the plurality of storage devices;
wherein each main board connector is one from a group consisting of a board-to-flex connector, a non-floating board-to-board connector, a floating board-to-board connector, and a compression-type connector.

14. A data storage system comprising:
a main printed circuit board (PCB) comprising at least one system controller circuitry; and
a plurality of stacked hard disk drives (HDDs), each HDD mechanically and electrically connected with the main PCB at or near a longitudinal end of the HDD;
wherein the system controller circuitry is positioned on the main PCB such that each electrical transmission line length between a respective HDD and the system controller circuitry is substantially equivalent.

15. The data storage system of claim 14, wherein:
the plurality of HDDs comprises a first grouping of four stacked HDDs connected with one lateral side of the main PCB and a second grouping of four stacked HDDs connected with the other lateral side of the main PCB; and
each electrical transmission line length between a respective HDD and the system controller circuitry is less than 100 millimeters (mm).

16. The data storage system of claim 15, wherein:
the system controller circuitry comprises single-channel circuitry; and
the main PCB comprises:
a first multiplexer circuitry between the system controller circuitry and the first and second groupings of HDDs;
a plurality of second multiplexer circuitry between the first multiplexer circuitry and each of the first and second groupings of HDDs; and
a T-connection between each second multiplexer circuitry and a pair of HDDs of each of the first and second groupings of HDDs.

17. The data storage system of claim 14, wherein:
the plurality of HDDs comprises a first grouping of four stacked HDDs connected with one lateral side of the main PCB and a second grouping of four stacked HDDs connected with the other lateral side of the main PCB;
the system controller circuitry comprises dual-channel circuitry; and
the main PCB comprises:
a first multiplexer circuitry between a first channel of the system controller circuitry and the first grouping of HDDs;
a second multiplexer circuitry between a second channel of the system controller circuitry and the second grouping of HDDs;
a first T-connection between the first multiplexer circuitry and a first pair of the first grouping of HDDs;
a second T-connection between the first multiplexer circuitry and a first pair of the second grouping of HDDs;
a third T-connection between the second multiplexer circuitry and a second pair of the first grouping of HDDs; and
a fourth T-connection between the second multiplexer circuitry and a second pair of the second grouping of HDDs.

18. The data storage system of claim 14, wherein:
each HDD of the plurality of HDDs comprises:
a plurality of disk media rotatably mounted on a motor spindle,
a plurality of head sliders, each head slider housing a read-write transducer configured to read from and to write to a disk medium of the plurality of disk media,
an actuator system configured for moving the plurality of head sliders to access portions of the disk media, and
electronics including a preamplifier, an actuation controller, a motor controller, and sensor circuitry; and
the main PCB further comprises power large scale integrated (PLSI) circuitry configured for sending signals to at least a portion of the electronics of each HDD through a multiplexer on the main PCB.

19. The data storage system of claim 14, wherein:
each HDD of the plurality of HDDs comprises:
a plurality of disk media rotatably mounted on a motor spindle,
means for housing a read-write transducer configured to read from and to write to a disk medium of the plurality of disk media,
means for moving the read-write transducers to access portions of the disk media, and
electronics including power large scale integrated (PLSI) circuitry, a preamplifier, an actuation controller, a motor controller, and sensor circuitry.

20. A data storage system comprising:
a main printed circuit board (PCB) comprising at least one system controller circuitry; and
multiple stacked hard disk drives (HDDs), each HDD mechanically and electrically connected with the main PCB at or near a longitudinal end of the HDD, wherein each HDD comprises:
disk media rotatably mounted on a motor spindle,
means for storing data by reading from and writing to a disk medium of the disk media,
means for moving the means for storing to access portions of the disk media, and electronics including a preamplifier, an actuation controller, a motor controller, and sensor circuitry;
wherein the system controller circuitry is positioned on the main PCB such that each electrical transmission line length between a respective HDD and the system controller circuitry is minimized.
